(19) United States
(12) Patent Application Publication
(10) Pub. No.: US 2015/0325382 A1
(43) Pub. Date: Nov. 12, 2015

(54) PHOTOELECTRIC CONVERSION ELEMENT

(71) Applicant: Panasonic Corporation, Osaka (JP)

(72) Inventors: MICHIO SUZUKA, Osaka (JP); TAKASHI SEKIGUCHI, Osaka (JP)

(21) Appl. No.: 14/685,411

(22) Filed: Apr. 13, 2015

(30) Foreign Application Priority Data
May 9, 2014 (JP) 2014-098024

(51) Int. Cl. H01G 9/20

(52) U.S. Cl. CPC H01G 9/2077

(57) ABSTRACT

A photoelectric conversion element includes first and second substrates; cells located between the first substrate and the second substrate and arranged in an aggregate, each of the cells including: a photoanode including a conductive layer located on the first substrate, a semiconductor layer located on the conductive layer, and a photosensitizer located on the semiconductor layer; a counter electrode located on the second substrate and facing the photoanode; and an electrolytic solution located between the photoanode and the counter electrode; a first sealing part located between two of the cells that adjoin each other, the first sealing part comprising a first sealing material and suppressing contact between the electrolytic solutions included in the two of the cells; and a second sealing part located on a periphery of the aggregate of the cells and comprising a second sealing material that has a higher Young's modulus than that of the first sealing material.

### BACKGROUND

1. Technical Field

The present disclosure relates to a photosensitized photoelectric conversion element. The term “photosensitized photoelectric conversion element” encompasses what is called dye-sensitized solar cells and also encompasses dye-sensitized power generation elements that can generate power even in environments having a relatively low illuminance, such as indoors.

2. Description of the Related Art

In recent years, dye-sensitized solar cells employing dyes as photosensitizers have been developed. A typical dye-sensitized solar cell includes a photoanode containing a dye, a counter electrode, and an electrolytic solution disposed between the photoanode and the counter electrode and containing a redox couple.

Dye-sensitized solar cells individually used as unit cells each provide a voltage output of as low as about 0.7 V. Thus, in order to use dye-sensitized solar cells for higher-voltage applications, production of modules each including cells has been studied.

A dye-sensitized solar cell module includes a plurality of cells connected in series, for example. Each cell includes an electrolytic solution between a photoanode and a counter electrode, for example. Thus, each cell needs to be sealed so as to confine the electrolytic solution.

Japanese Unexamined Patent Application Publication No. 2010-257857 discloses a solar cell module that includes partitions separating the electrolytic solutions of cells from each other, for example.

### SUMMARY

There has been a demand for an increase in the aperture ratios of photoelectric conversion elements such as dye-sensitized solar cell modules. The term “aperture ratio” of a module denotes the ratio of the area of a light-receiving region (light-receiving area) to the area of the module. The aperture ratio is determined by dividing the light-receiving area by the whole area of the module. In order to increase the light-receiving area, for example, Japanese Unexamined Patent Application Publication No. 2010-257857 discloses that partition walls disposed between neighboring cells are formed so as to have a smaller thickness than exterior partition walls.

The inventor of the present disclosure performed studies, from a novel perspective, on the structure of a photoelectric conversion element that has a function of confining an electrolytic solution therein and also has a high aperture ratio.

One non-limiting and exemplary embodiment provides a photoelectric conversion element having a novel structure that can provide a function of confining an electrolytic solution therein with certainty and can also have a high aperture ratio.

In one general aspect, the techniques disclosed here feature a photoelectric conversion element including a first substrate; a second substrate facing the first substrate; cells located between the first substrate and the second substrate and arranged in an aggregate in a direction parallel to a surface of the first substrate, each of the cells including: a photoanode including a conductive layer located on the first substrate, a semiconductor layer located on the conductive layer, and a photosensitizer located on the semiconductor layer; a counter electrode located on the second substrate and facing the photoanode; and an electrolytic solution located between the photoanode and the counter electrode; a first sealing part located between two of the cells that adjoin each other, the first sealing part comprising a first sealing material and suppressing contact between the electrolytic solutions included in the two of the cells; and a second sealing part located on a periphery of the aggregate of the cells and comprising a second sealing material that has a higher Young's modulus than a Young's modulus of the first sealing material.

It should be noted that general or specific embodiments may be implemented as a device, a system, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a top view of a photoelectric conversion element according to an embodiment of the present disclosure and FIG. 1B is a sectional view of the photoelectric conversion element taken along line IB-IB in FIG. 1A;

FIG. 2A is a top view of a photoelectric conversion element according to another embodiment of the present disclosure and FIG. 2B is a sectional view of the photoelectric conversion element taken along line IIB-IIB in FIG. 2A;

FIGS. 3A and 3B are sectional views illustrating production steps of a photoelectric conversion element; and

FIGS. 4A to 4C are schematic views illustrating production steps of a photoelectric conversion element.

### DETAILED DESCRIPTION

The present disclosure encompasses photoelectric conversion elements described in the following Items.

### Item 1

A photoelectric conversion element including:

a first substrate;

a second substrate facing the first substrate;

cells located between the first substrate and the second substrate and arranged in an aggregate in a direction parallel to a surface of the first substrate, each of the cells including: a photoanode including a conductive layer located on the first substrate, a semiconductor layer located on the conductive layer, and a photosensitizer located on the semiconductor layer; a counter electrode located on the second substrate and facing the photoanode; and an electrolytic solution located between the photoanode and the counter electrode;

a first sealing part located between two of the cells that adjoin each other, the first sealing part comprising a first sealing material and suppressing contact between the electrolytic solutions included in the two of the cells; and

a second sealing part located on a periphery of the aggregate of the cells and comprising a second sealing material that has a higher Young's modulus than a Young's modulus of the first sealing material.

### Item 2

The photoelectric conversion element according to Item 1, wherein a Young's modulus of the first sealing material is 1 MPa or more and 500 MPa or less.

### Item 3

The photoelectric conversion element according to Item 2, wherein the Young's modulus of the first sealing material is 20 MPa or less.

### Item 4

The photoelectric conversion element according to any one of Items 1 to 3, wherein the first sealing material is a silicone rubber.

### Item 5

The photoelectric conversion element according to any one of Items 1 to 3, wherein the first sealing material is an acrylate resin.

### Item 6

The photoelectric conversion element according to any one of Items 1 to 5, wherein, when viewed from a normal direction of the surface of the first substrate, a thickness of the first sealing part is smaller than a thickness of the second sealing part.

### Item 7

The photoelectric conversion element according to any one of Items 1 to 6, wherein, when viewed from a normal direction of the surface of the first substrate, the thickness of the first sealing part is 1 mm or less.

### Item 8

The photoelectric conversion element according to any one of Items 1 to 5, wherein the first sealing part is compressed between the first substrate and the second substrate.

### EMBODIMENTS

Hereinafter, embodiments according to the present disclosure will be described with reference to the drawings.

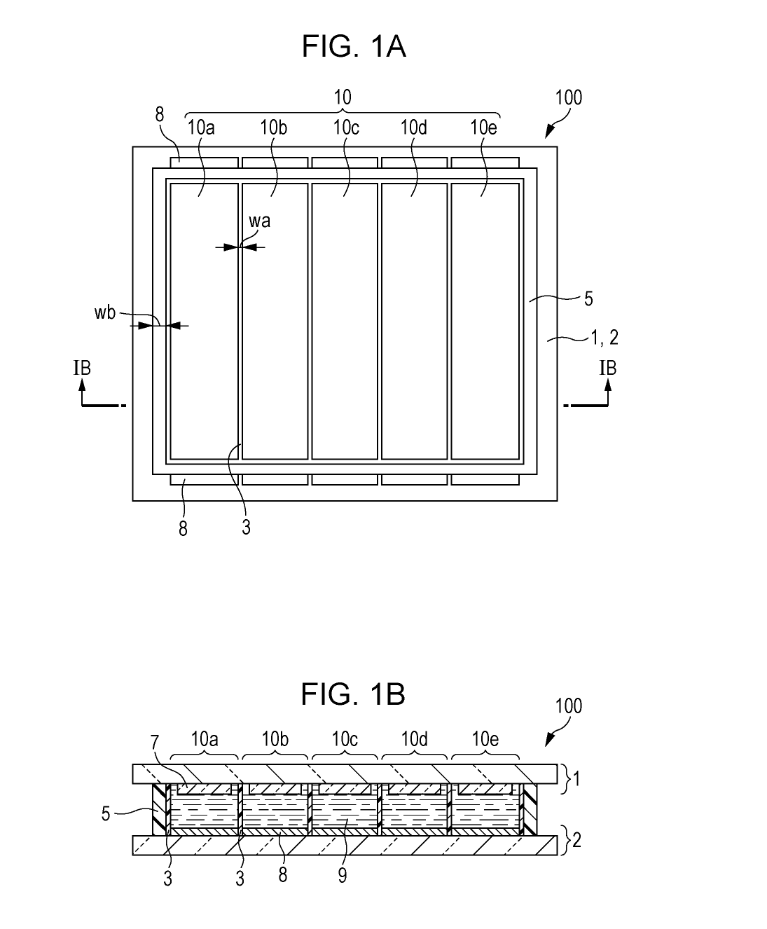

FIGS. 1A and 1B schematically illustrate the structure of a photoelectric conversion element 100 according to an embodiment of the present disclosure. FIG. 1A is a top view of the photoelectric conversion element 100 and FIG. 1B is a sectional view of the photoelectric conversion element 100 taken along line IB-IB in FIG. 1A.

The photoelectric conversion element 100 includes a first substrate 1; a second substrate 2 disposed so as to face the first substrate 1; and a plurality of cells 10 that are disposed between these substrates 1 and 2. In this embodiment, five cells 10a to 10e are arranged in a row. However, the number and arrangement pattern of the cells 10 are not limited to this embodiment. The plurality of cells 10 are connected in series through wiring (not shown). The first substrate 1 may be a substrate that transmits visible light.

Each cell 10 includes a photoanode 7, a counter electrode 8, and an electrolytic solution 9 disposed between the photoanode 7 and the counter electrode 8.

The photoanode 7 is supported on the first substrate 1. The photoanode 7 includes, for example, a conductive layer that transmits visible light (sometimes referred to as a transparent conductive layer) and a semiconductor layer formed on the conductive layer (not shown). The semiconductor layer contains dye molecules serving as a photosensitizer. The semiconductor layer is, for example, a porous semiconductor layer formed of porous titanium oxide.

The counter electrode 8 is supported on the second substrate 2 and is disposed so as to face the photoanode 7 (the semiconductor layer of the photoanode 7) with the electrolytic solution 9 therebetween. The counter electrode 8 includes, for example, a conductive oxide layer and a metal layer (for example, a platinum layer) formed on the conductive oxide layer (not shown).

The photoelectric conversion element 100 also includes a first sealing part 3 and a second sealing part 5 for confining the electrolytic solutions 9. The first sealing part 3 is disposed between neighboring cells of the plurality of cells 10 so as to be in contact with the electrolytic solutions 9. The second sealing part 5 is disposed on the periphery of the plurality of cells 10 so as to surround the plurality of cells 10. Thus, when viewed in a direction normal to the first substrate 1, the second sealing part 5 is positioned outside the first sealing part 3. The first sealing part 3 is formed of a sealing material different from that of the second sealing part 5.

In the photoelectric conversion element 100 of this embodiment, two different functions of confining the electrolytic solutions 9 are defined and these functions are individually provided by the use of different sealing parts.

Specifically, the first sealing part 3 has a function of suppressing a short circuit between neighboring cells 10, in particular, the contact between the electrolytic solutions 9 of neighboring cells, which is referred to as liquid junction. The second sealing part 5 surrounds the plurality of cells 10 (module) to thereby suppress leakage of gas generated by evaporation of the electrolytic solutions 9 and suppress leakage of the electrolytic solutions 9 itself. In this embodiment, the sealing part 3 is formed of a material different from that of the sealing part 5. In this way, the sealing parts 3 and 5 can be individually formed of sealing materials that are optimal for the required functions.

The second sealing part 5 may additionally have a function of bonding together the first substrate 1 having the photoanode 7 thereon and the second substrate 2 having the counter electrode 8 thereon. In this case, it is not necessary for the first sealing part 3 to have adhesion to the substrate 1 or 2. In other words, it is not necessary for the first sealing part 3 to bond to one or both of the first substrate 1 and the second substrate 2 or to contribute to bonding of the first substrate 1 and the second substrate 2 together.

The first sealing part 3 may have an appropriate elasticity and may be disposed so as to be compressed between the first substrate 1 and the second substrate 2 bonded together with the second sealing part 5. In this case, even when the width wa of the first sealing part 3 viewed from the direction normal to the first substrate 1 is decreased, the electrolytic solutions 9 can be confined with more certainty. Thus, a decrease in the width wa results in an increase in the ratio of the area of the light-receiving region to the area of the photoelectric conversion element 100. This results in an increase in the aperture ratio of the photoelectric conversion element 100. As a result, the power generated per unit area of the photoelectric conversion element 100 can be increased.

The first sealing part 3 is formed by, for example, disposing a sealing material in a predetermined pattern on one of the substrates. The first sealing part 3 formed on the substrate deforms by being compressed during a pressing step of bonding together the first substrate 1 and the second substrate 2. The first sealing part 3 that has been formed on the substrate and that is to be compressed may have irregularities in the top surface thereof. In particular, in a case where the sealing material is disposed by screen printing or the like to achieve a small wa, the resultant first sealing part 3 has a top surface having a high degree of surface roughness. Even in such a case, the first sealing part 3 desirably deforms by pressure applied during pressing the first and second substrates together such that the first sealing part 3 appropriately fills the gap between these substrates.

The first sealing part 3 may be formed of a sealing material that can deform under a predetermined pressing condition so as to flatten the irregularities. For example, the first sealing part 3 may be formed of an elastic sealing material having a Young's modulus of 500 MPa or less. In this case, the occurrence of liquid junction can be more effectively suppressed. The Young's modulus is defined by the following equation.

Strain ε=Stress σ/Young's modulus E

In a case where the first sealing part 3 is formed of a sealing material having a Young's modulus of 500 MPa or less, the first sealing part 3 can deform such that the irregularities in the top surface thereof are sufficiently flattened (the degree of surface roughness is sufficiently decreased) during a pressing step of a normal production process of solar cells (pressure applied between substrates: for example, 100 kPa to 1000 kPa). In order to flatten the irregularities with more certainty, the sealing material desirably has a Young's modulus of 20 MPa or less. The sealing material of the first sealing part 3 has a Young's modulus of, for example, 1 MPa or more. Such a sealing material having a Young's modulus of 1 MPa or more can sufficiently maintain a freestanding state and hence can provide the effect of suppressing liquid junction with more certainty.

The second sealing part 5 is formed of a sealing material that at least exhibits a high adhesion to the first substrate 1 and the second substrate 2. This sealing material is not limited in terms of Young's modulus. The second sealing part 5 at least keeps the first substrate 1 and the second substrate 2 bonded together while the first sealing part 3 is compressed. For this reason, the sealing material of the second sealing part 5 desirably has a higher Young's modulus than the sealing material of the first sealing part 3. In this case, while the first substrate 1 and the second substrate 2 are sufficiently bonded to the second sealing part 5, the first sealing part 3 can confine the electrolytic solutions 9 with more certainty.

When viewed in a direction normal to the first substrate 1, the width wa of the first sealing part 3 may be smaller than the width wb of the second sealing part 5, for example. In this case, while the electrolytic solutions 9 are sufficiently confined and the first substrate 1 and the second substrate 2 are bonded together at a sufficiently high bonding strength, the aperture ratio can be increased.

In order to more effectively increase the aperture ratio, the width wa of the first sealing part 3 may be set to 1 mm or less, desirably less than 1 mm, more desirably 0.7 mm or less. The width wa of the first sealing part 3 is desirably as small as possible as long as the electrolytic solutions 9 are confined. However, from the standpoint of the production process, the degree to which the width wa can be decreased is limited. For example, in a case where the first sealing part 3 is formed by a process described below, the lower limit of the width wa of the first sealing part 3 is about 0.1 mm. From the standpoint of the production process being carried out and the capability of confining the electrolytic solutions 9, the width wa of the first sealing part 3 is desirably set to 0.2 mm or more.

Examples of the sealing material forming the first sealing part 3 include silicone rubbers, resin materials having a silanol group such as silicone resins, rubber resins having an unsaturated bond such as butadiene rubbers, copolymers of the foregoing such as ABS rubbers, and acrylate resins.

The sealing material forming the second sealing part 5 can be appropriately selected from commonly used sealing materials for dye-sensitized solar cells. Examples of the sealing material include adhesives curable by light or heat (such as acrylate resins and epoxy resins) and hot-melt adhesives (such as polyethylene resins). Alternatively, sealing can be achieved with a hard material such as glass frit.

The first sealing part 3 and the second sealing part 5 may have openings (not shown) through which the electrolytic solution 9 is injected into cells. The number of openings per cell may be one or more. Typically, one opening is formed for each cell. The size of the opening (maximum width; diameter in a case where the opening is circular) is about 1 mm to about 2 mm.

Portions of the counter electrodes 8 may extend outside the region sealed with the second sealing part 5. Such portions of the counter electrodes 8 positioned outside the region sealed with the second sealing part 5 can be used for establishing an electrical connection between the cells 10 or to the outside.

In the embodiment illustrated in FIGS. 1A and 1B, the electrolytic solutions 9 of neighboring cells 10 are separated from each other only by the first sealing part 3. The first sealing part 3 is formed so as to surround individual cells. The second sealing part 5 is disposed outside the first sealing part 3 and is not in contact with the electrolytic solutions 9. In this embodiment, the plurality of cells 10 are double-sealed with the first sealing part 3 and the second sealing part 5. Thus, in particular, corners of each cell can be sealed with more certainty so as to confine the electrolytic solution 9 therein.

The configuration of the sealing parts 3 and 5 of this embodiment is not limited to that illustrated in FIGS. 1A and 1B. For example, another configuration may be employed in which the first sealing part 3 is not disposed on the periphery of the plurality of cells 10.

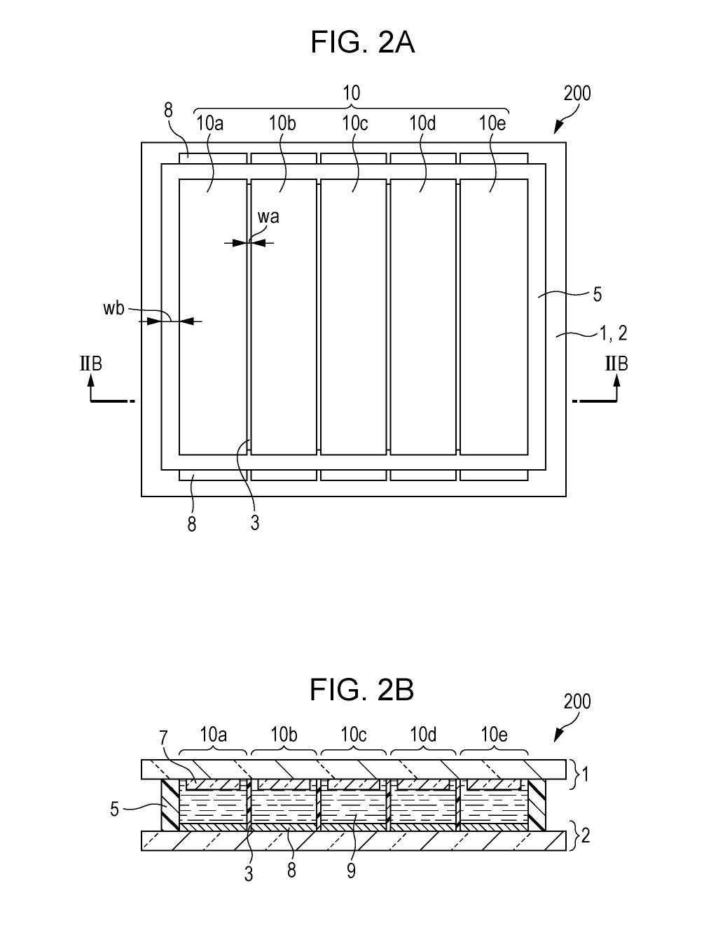

FIGS. 2A and 2B are respectively the top view and sectional view of a photoelectric conversion element 200 according to another embodiment. FIG. 2B illustrates a section of the photoelectric conversion element 200 taken along line IIB-IIB in FIG. 2A.

In the photoelectric conversion element 200, the first sealing part 3 is disposed only regions sandwiched between neighboring cells 10. In other words, the first sealing part 3 is not disposed for sides of the cells 10, the sides not facing another cell. The other structures are the same as those of the photoelectric conversion element 100 illustrated in FIGS. 1A and 1B and are not described here. The photoelectric conversion element 200 has such a configuration in which only the second sealing part 5 is disposed on the periphery of the plurality of cells 10. Thus, the area of the regions not contributing to photoelectric conversion can be decreased, which can result in a further increase in the aperture ratio.

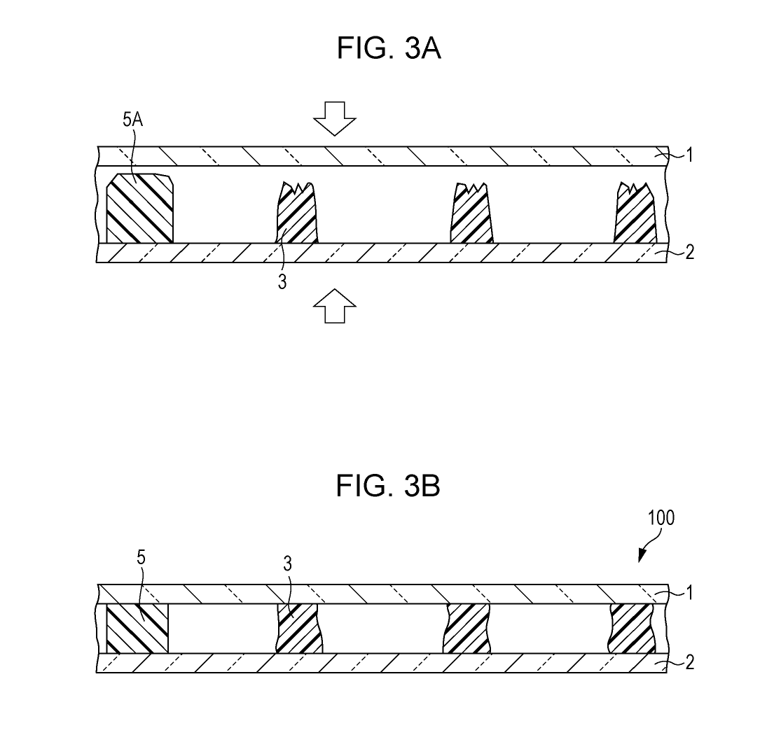

Hereinafter, an example of a method for producing the photoelectric conversion element 100 according to the embodiment will be described with reference to FIGS. 3A and 3B.

FIGS. 3A and 3B are sectional views schematically illustrating steps of an example of a method for producing the photoelectric conversion element 100.

Referring to FIG. 3A, the first sealing part 3 is formed in a predetermined pattern on one of the substrates (in this example, on the second substrate 2 having counter electrodes).

The first sealing part 3 may be formed by a process allowing high-precision formation such as printing or a process using a dispenser. Alternatively, a commonly used film-formation process may be obviously employed, such as a process using a bar coater, a doctor blade process, or drop casting. Alternatively, a sealing material may be shaped into a predetermined shape and this shaped material may be mounted onto a substrate to form the first sealing part 3. Referring to FIG. 3A, some formation processes can provide the first sealing part 3 having irregularities in the top surface. In particular, in a case where a high-precision process (such as screen printing) is used to form the first sealing part 3 having a small width wa, the top surface of the first sealing part 3 can have a high degree of surface roughness.

Subsequently, a sealing agent 5A such as a thermosetting resin is placed on the second substrate 2 having the first sealing part 3. After that, the other substrate (in this example, the first substrate 1 having photoanodes) is placed onto the second substrate 2. These substrates 1 and 2 are pressed to be bonded together. In another case where, for example, a hot-melt adhesive is used as the sealing agent 5A, the sealing agent 5A being pressed is heated and then cooled to solidify so that the substrates 1 and 2 can be bonded together. In a case where, for example, a thermosetting resin is used as the sealing agent 5A, the sealing agent 5A being pressed is heated to thereby be cured. In another case where, for example, an UV-curable resin is used as the sealing agent 5A, the sealing agent 5A being pressed is irradiated with ultraviolet rays to thereby be cured. In this specification, the term “sealing agent” and the term “sealing material” are defined as different terms. The term “sealing agent” denotes a material that is applied to a substrate and is to be cured. The term “sealing material” denotes a material having cured or solidified.

Referring to FIG. 3B, the second sealing part 5 is thus formed. The first substrate 1 and the second substrate 2 are bonded together with the second sealing part 5. The first sealing part 3 is compressed so as to fill the gap between the first substrate 1 and the second substrate 2. In this example, the first sealing part 3 is disposed such that the extent of the irregularities in the top surface is reduced and the whole top surface is substantially in contact with the first substrate 1.

After that, the electrolytic solution 9 is injected (not shown) into cells defined by the first and second sealing parts 3 and 5. Thus, a photoelectric conversion element is obtained.

Hereinafter, components of the photoelectric conversion element 100 will be described more specifically.

### Photoanode 7

As described above, the photoanode 7 includes, for example, a conductive layer that transmits visible light and a semiconductor layer formed on the conductive layer. The semiconductor layer contains a photosensitizer. The semiconductor layer containing a photosensitizer is sometimes referred to as a light-absorbing layer. The substrate used here is, for example, a glass substrate or a plastic substrate (the term “plastic substrate” encompasses a plastic film) that transmits visible light.

The conductive layer that transmits visible light can be formed of, for example, a material that transmits visible light (hereafter referred to as “transparent conductive material”). Examples of the transparent conductive material include conductive metal oxides such as indium-tin double oxide, tin oxide doped with antimony, and tin oxide doped with fluorine, and combinations of the foregoing. Alternatively, the conductive layer that transmits visible light may be formed of a conductive material that does not pass light therethrough. For example, the conductive layer may be a metal layer having a pattern made up of straight lines (stripe pattern) or wavy lines, a grid pattern (mesh pattern), or a perforated-metal pattern (pattern in which a large number of fine through-holes are arranged at regular or irregular intervals); or a metal layer having a pattern inverse to such a pattern. In such a metal layer, light can pass through apertures formed in the metal layer. Examples of a metal usable for forming the metal layer include platinum, gold, silver, copper, aluminum, rhodium, indium, titanium, iron, nickel, tin, zinc, and alloys containing one or more of the foregoing. Alternatively, instead of metal, a conductive carbon material may be used to form the conductive layer.

The conductive layer that transmits visible light may have a transmittance of, for example, 50% or more, or 80% or more. The wavelength of light that the conductive layer transmits is set in accordance with the absorption wavelength of the photosensitizer used. The conductive layer may have a thickness, for example, in the range of 1 to 100 nm.

In a case where the semiconductor layer receives light on a side of the photoelectric conversion element, the side being opposite to the first substrate 1, it is not necessary that the first substrate 1 and the conductive layer transmit visible light. Thus, in a case where this conductive layer is formed of metal or carbon as described above, formation of apertures in the metal or carbon layer is not necessary. In a case where such a material of the conductive layer has a sufficiently high strength, the conductive layer can be formed so as to also function as the substrate.

In order to suppress electron leakage occurring in the surface of the conductive layer, that is, in order to provide an rectifying effect between the conductive layer and the semiconductor layer, an oxide layer formed of, for example, silicon oxide, tin oxide, titanium oxide, zirconium oxide, or aluminum oxide may be formed between the conductive layer and the semiconductor layer.

As described above, the semiconductor layer containing a photosensitizer includes, for example, a porous semiconductor material and a photosensitizer loaded on the surface of the porous semiconductor material. The porous semiconductor material is, for example, porous titanium oxide (TiO₂). Titanium oxide is advantageous in that it has excellent photoelectric conversion characteristics and it tends not to undergo photodissolution into electrolytic solutions. The term “photodissolution” denotes a phenomenon in which a substance exposed to light energy is itself chemically changed and then dissolved in a solution. A porous material is advantageous in that it has a large specific surface area and can be loaded with a large amount of a photosensitizer. Alternatively, instead of porous material, the semiconductor layer may be formed of, for example, aggregated semiconductor particles.

The semiconductor layer may have a thickness of, for example, 0.01 μm or more and 100 μm or less. The thickness of the semiconductor layer may be appropriately changed in consideration of photoelectric conversion efficiency. The semiconductor layer may have a thickness of 0.5 μm or more and 50 μm or less, or a thickness of 1 μm or more and 20 μm or less. The semiconductor layer desirably has a high degree of surface roughness: a surface roughness coefficient given as effective area/projected area is desirably 10 or more, more desirably 100 or more. The term “effective area” denotes an effective surface area calculated from a volume determined from the projected area and thickness of the semiconductor layer and the specific surface area and bulk density of the material forming the semiconductor layer.

The semiconductor layer may be formed of TiO₂ or another inorganic semiconductor. Examples of the inorganic semiconductor include oxides of metal elements such as Cd, Zn, In, Pb, Mo, W, Sb, Bi, Cu, Hg, Ti, Ag, Mn, Fe, V, Sn, Zr, Sr, Ga, Si, and Cr; perovskites such as SrTiO₃ and CaTiO₃; sulfides such as CdS, ZnS, In₂S₃, PbS, Mo₂S, WS₂, Sb₂S₃, Bi₂S₃, ZnCdS₂, and Cu₂S; metal chalcogenides such as CdSe, In₂Se₃, WSe₂, HgS, PbSe, and CdTe; and GaAs, Si, Se, Cd₂P₃, Zn₂P₃, InP, AgBr, PbI₂, HgI₂, and BiI₃. Of these, CdS, ZnS, In₂S₃, PbS, Mo₂S, WS₂, Sb₂S₃, Bi₂S₃, ZnCdS₂, Cu₂S, InP, Cu₂O, CuO, and CdSe are advantageous in that they can absorb light at a wavelength in the range of about 350 nm to about 1300 nm. The semiconductor layer may also be formed of a composite material containing at least one selected from the above-described semiconductors. Examples of the composite material include CdS/TiO₂, CdS/AgI, Ag₂S/AgI, CdS/ZnO, CdS/HgS, CdS/PbS, ZnO/ZnS, ZnO/ZnSe, CdS/HgS, CdSₓ/CdSe₁₋ₓ, CdSₓ/Te₁₋ₓ, CdSeₓ/Te₁₋ₓ, ZnS/CdSe, ZnSe/CdSe, CdS/ZnS, TiO₂/Cd₃P₂, CdS/CdSeCd_{y}Zn_{1-y}S, and CdS/HgS/CdS. The semiconductor layer may also be formed of an organic semiconductor such as polyphenylenevinylene, polythiophene, polyacetylene, tetracene, pentacene, or phthalocyanine.

The semiconductor layer can be formed by a method appropriately selected from various known methods. In a case of using an inorganic semiconductor, for example, a mixture of powder of the semiconductor material and an organic binder (containing an organic solvent) is disposed onto the conductive layer; and a heat treatment is subsequently carried out to remove the organic binder, so that a semiconductor layer formed of the inorganic semiconductor can be obtained. The method for disposing the mixture onto the conductive layer can be appropriately selected from various known application methods and printing methods. Examples of the application methods include a doctor blade method, a bar coating method, a spraying method, a dip coating method, and a spin-coating method. An example of the printing methods is a screen printing method. If necessary, the film of the mixture may be pressed.

In a case of using an organic semiconductor, the semiconductor layer can also be formed by a method appropriately selected from various known methods. A solution of an organic semiconductor may be disposed onto the conductive layer by a method appropriately selected from various known application methods and printing methods. In a case of using, for example, a polymer semiconductor having a number-average molecular weight of 1000 or more, examples of usable methods include application methods such as a spin-coating method and a drop-casting method and printing methods such as screen printing and gravure printing. Instead of such wet processes, a dry process such as a sputtering method or a vapor deposition method may also be employed.

Examples of the photosensitizer include semiconductor ultrafine particles, dyes, and pigments. The photosensitizer may be an inorganic material, an organic material, or a mixture of these. From the standpoint of efficient light absorption and charge separation, the photosensitizer may be a dye. Examples of the dye include 9-phenylxanthene dyes, coumarin dyes, acridine dyes, triphenylmethane dyes, tetraphenylmethane dyes, quinone dyes, azo dyes, indigo dyes, cyanine dyes, merocyanine dyes, and xanthene dyes; transition-metal complexes such as a ruthenium-cis-diaqua-bipyridyl complex of RuL₂(H₂O)₂ type (where L represents 4,4′-dicarboxyl-2,2′-bipyridine), ruthenium-tris(RuL₃), ruthenium-bis(RuL₂), osmium-tris(OsL₃), and osmium-bis(OsL₂), zinc-tetra(4-carboxyphenyl)porphyrin, iron-hexacyanide complexes, and phthalocyanines; and dyes described in the chapter regarding DSSC in “Latest technology and material developments regarding FPD, DSSC, optical memory, and functional dyes” (NTS Inc.). Of these, in cases of using dyes having a characteristic to aggregate, dye molecules may aggregate tightly to thereby cover the surface of a semiconductor material and to function as an insulating layer. A photosensitizer thus functioning as an insulating layer can impart a rectifying effect to a charge separation interface (interface between photosensitizer and semiconductor material), so that recombination of charges after charge separation can be suppressed.

Such a dye having a characteristic to aggregate desirably has a dye molecule structure represented by the following Chemical formula 1. An example of this dye molecule structure is illustrated as Chemical formula 2 below. Whether dye molecules form aggregate or not can be easily determined by comparison between the absorption spectrum of dye molecules dissolved in an organic solvent or the like and the absorption spectrum of the dye molecules loaded on a semiconductor material.

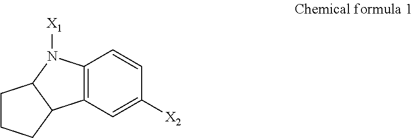

(where X₁ and X₂ each independently include at least one group selected from the group consisting of alkyl groups, alkenyl groups, aralkyl groups, aryl groups, and heterocycles; such at least one groups may each independently have a substituent; and X₂ includes, for example, a carboxyl group, a sulfonyl group, or a phosphonyl group.)

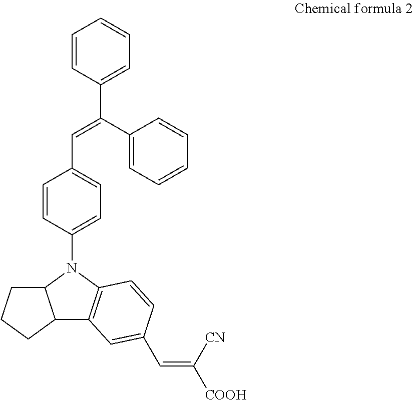 [SMILES: N#C/C(=C\c1ccc2c(c1)C1CCCC1N2c1ccc(C=C(c2ccccc2)c2ccccc2)cc1)C(=O)O]

Examples of the semiconductor ultrafine particles usable as the photosensitizer include ultrafine particles of sulfide semiconductors such as cadmium sulfide, lead sulfide, and silver sulfide. Such semiconductor ultrafine particles have a diameter of, for example, 1 to 10 nm.

The photosensitizer can be loaded on a semiconductor by a method appropriately selected from various known methods. For example, a substrate having a semiconductor layer (for example, a porous semiconductor not containing any photosensitizer) is immersed in a solution in which a photosensitizer is dissolved or dispersed. The medium of this solution may be appropriately selected from media that can dissolve the photosensitizer therein, such as water, alcohol, toluene, and dimethylformamide. During immersion of the substrate in the solution containing the photosensitizer, the solution may be heated or ultrasonic waves may be applied to the solution. After being immersed, the substrate may be washed with a solvent (such as alcohol) and/or heated to thereby remove excess photosensitizer.

The amount of the photosensitizer loaded on a semiconductor is, for example, within the range of 1×10⁻¹⁰ to 1×10⁻⁴ mol/cm². From the standpoint of photoelectric conversion efficiency and cost, this amount may be, for example, within the range of 0.1×10⁻⁸ to 9.0×10⁻⁶ mol/cm².

### Counter Electrode 8

The counter electrode 8 functions as the positive electrode of the photoelectric conversion element. Examples of the material forming the counter electrode 8 include metals such as platinum, gold, silver, copper, aluminum, rhodium, and indium; carbon materials such as graphite, carbon nanotubes, and platinum on carbon; conductive metal oxides such as indium-tin double oxide, tin oxide doped with antimony, and tin oxide doped with fluorine; and conductive polymers such as polyethylenedioxythiophene, polypyrrole, and polyaniline. Of these, for example, platinum, graphite, or polyethylenedioxythiophene is desirably used to form the counter electrode 8.

### Electrolyte Solution (Electrolytic Solution) 9

The electrolytic solution contains a supporting electrolyte (supporting salt) and a solvent.

Examples of the supporting electrolyte include ammonium salts such as tetrabutylammonium perchlorate, tetraethylammonium hexafluorophosphate, imidazolium salts, and pyridinium salts; and alkali metal salts such as lithium perchlorate and potassium tetrafluoroborate.

The solvent desirably has a high ion conductivity. The solvent may be selected from aqueous solvents and organic solvents. In order to achieve higher stabilization of the solute, the solvent is desirably selected from organic solvents. Examples of the solvent include carbonate compounds such as dimethyl carbonate, diethyl carbonate, methyl ethyl carbonate, ethylene carbonate, and propylene carbonate; ester compounds such as methyl acetate, methyl propionate, and γ-butyrolactone; ether compounds such as diethyl ether, 1,2-dimethoxyethane, 1,3-dioxosilane, tetrahydrofuran, and 2-methyltetrahydrofuran; heterocyclic compounds such as 3-methyl-2-oxazolidinone and 2-methylpyrrolidone; nitrile compounds such as acetonitrile, methoxyacetonitrile, and propionitrile; and aprotic polar compounds such as sulfolane, dimethyl sulfoxide, and dimethylformamide. These compounds may be used alone or in combination of two or more thereof. Of these, carbonate compounds such as ethylene carbonate and propylene carbonate, heterocyclic compounds such as γ-butyrolactone, 3-methyl-2-oxazolidinone, and 2-methylpyrrolidone, and nitrile compounds such as acetonitrile, methoxyacetonitrile, propionitrile, 3-methoxypropionitrile, and valeronitrile are desirable.

The solvent may be selected from ionic liquids or mixtures of ionic liquids and the above-described solvents. Use of such an ionic liquid can enhance the effect of stabilizing the oxidation-reduction portion of the solid compound layer that the electrolytic solution comes into contact with. Ionic liquids are also advantageous in that they have low volatility and high incombustibility.

The solvent may be appropriately selected from any known ionic liquids. Examples of the ionic liquids include imidazolium ionic liquids such as 1-ethyl-3-methylimidazolium tetracyanoborate, pyridine ionic liquids, alicyclic amine ionic liquids, aliphatic amine ionic liquids, azonium amine ionic liquids, and the ionic liquids described in the following documents: European Patent No. 718288; International Publication No. 95/18456; DENKI KAGAKU, vol. 65, No. 11, p. 923 (1997); J. Electrochem. Soc. vol. 143, No. 10, p. 3099 (1996); and Inorg. Chem. vol. 35, p. 1168 (1996).

### EXAMPLES

Hereinafter, the present disclosure will be specifically described with reference to Examples.

### Example 1

A photoelectric conversion module was produced so as to include the following components.

First substrate: glass substrate having thickness of 1 mm

Photoanodes:
Transparent conductive film: fluorine-doped SnO₂ layer (surface resistance: 10 Ω/square)
Semiconductor layer: porous titanium oxide and photosensitizing dye (D358 manufactured by Mitsubishi Paper Mills Ltd.)

Electrolytic solution: electrolytic solution containing TEMPO in ethylmethylimidazolium bis(trifluoromethanesulfonyl)imide

Second substrate: glass substrate having thickness of 1 mm

Conductive oxide layer: fluorine-doped SnO₂ layer (surface resistance: 10 Ω/square)

Counter electrodes: platinum electrodes

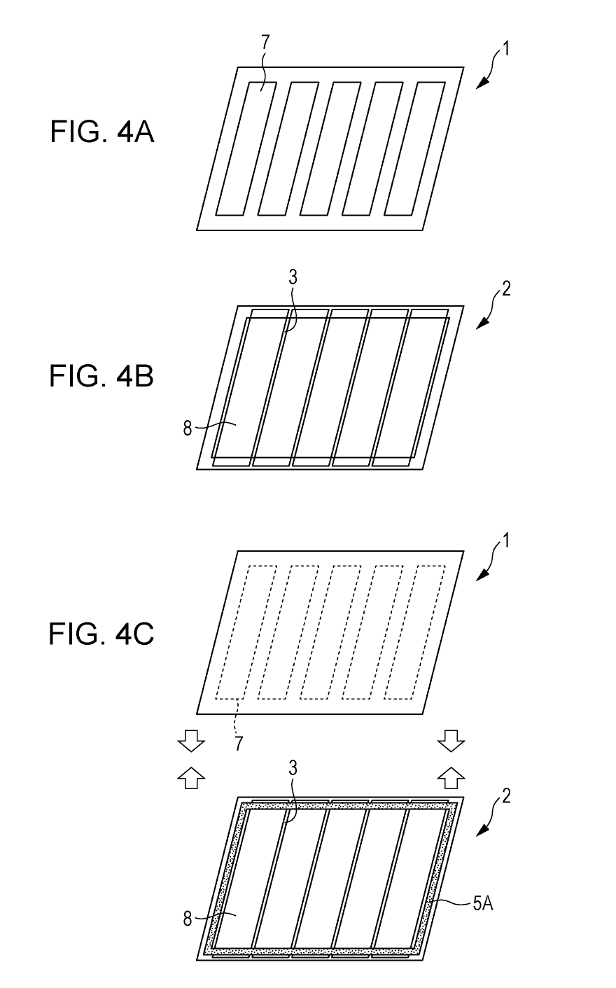

The photoelectric conversion module in Example 1 was produced in the following manner. FIGS. 4A to 4C are schematic views illustrating a method for producing the photoelectric conversion module in Example 1.

Two glass substrates having a conductive layer (fluorine-doped SnO₂ layer) thereon and a thickness of 1 mm (manufactured by Asahi Glass Co., Ltd.) were prepared.

Referring to FIG. 4A, the photoanodes 7 were subsequently formed on one of the glass substrates to thereby produce the first substrate 1. Specifically, the first substrate 1 was produced in the following manner.

A high-purity titanium oxide powder having an average primary particle size of 20 nm was dispersed in ethylcellulose to thereby prepare paste for screen printing.

A titanium oxide layer having a thickness of about 10 nm was formed as a semiconductor layer by sputtering on the fluorine-doped SnO₂ layer of one of the glass substrates. Subsequently, the above-described paste was applied to this titanium oxide layer and dried. The resultant dried substance was then fired at 500° C. for 30 minutes in the air to thereby form a porous titanium oxide layer (titanium coating) having a thickness of 2 μm. After that, the titanium oxide layer and the underlying fluorine-doped SnO₂ layer were patterned. As a result, the titanium oxide layer was patterned into five rectangular strips arranged adjacent to one another and each having dimensions of 25 mm×10 mm.

Subsequently, the substrate having the porous titanium oxide layer thereon was immersed in a solvent mixture (acetonitrile:butanol=1:1) containing 0.3 mM of the photosensitizing dye represented by the following Chemical formula 3 (D358 manufactured by Mitsubishi Paper Mills Ltd.) and left at rest at room temperature for 16 hours in a dark place, so that the photosensitizer was loaded in the porous titanium oxide layer. Thus, the photoanodes 7 including the transparent conductive layer and the titanium oxide layer were formed.

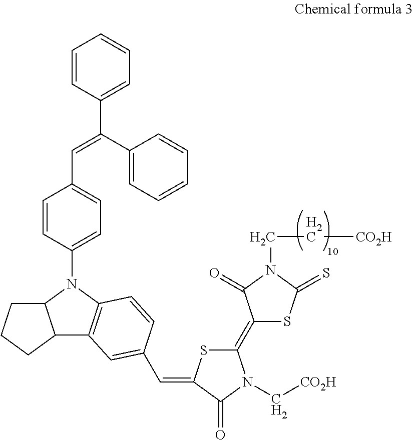

Referring to FIG. 4B, the counter electrodes 8 were formed on the other glass substrate to thereby provide the second substrate 2. The counter electrodes 8 were formed in the following manner: a platinum film was deposited by sputtering on the surface of the glass substrate and the platinum film was patterned. During this patterning, the platinum film and the underlying fluorine-doped SnO₂ layer were patterned. As a result, five counter electrodes 8 arranged in a pattern corresponding to that of the photoanodes 7 were formed. The counter electrodes 8 were formed so as to have a length larger than that (25 mm) of the photoanodes 7.

After that, the first sealing part 3 was formed on the second substrate 2. Specifically, the first sealing part 3 was formed in the following manner.

On the second substrate 2 having the counter electrodes 8 thereon, silicone resin films having a width of 0.5 mm were formed by screen printing through a screen having a pattern corresponding to that of the first sealing part 3 illustrated in FIG. 4B. The silicone resin used was a one-component condensation RTV silicone resin (Shin-Etsu Silicone, KE-45-TS). Subsequently, the silicone resin was dried at 100° C. for 10 minutes. Thus, the first sealing part 3 was formed. When viewed in the direction normal to the second substrate 2, the first sealing part 3 had a pattern constituted by rectangles; the short sides of each rectangle extend across the corresponding counter electrode 8; and long sides of the rectangles extend so as to separate neighboring counter electrodes 8 from each other.

Referring to FIG. 4C, subsequently, a hot-melt adhesive serving as the sealing agent 5A was disposed on the second substrate 2 so as to surround the region in which the first sealing part 3 was formed (the region in which cells were to be formed). Specifically, the sealing agent 5A was disposed such that portions (both ends) of the counter electrodes 8 were positioned outside the region surrounded by the sealing agent 5A. The sealing agent 5A used was a polyethylene resin adhesive (manufactured by DU PONT-MITSUI POLYCHEMICALS CO., LTD.).

Subsequently, the first substrate 1 illustrated in FIG. 4A was placed onto the second substrate 2 on which the sealing agent 5A was disposed. These substrates being heated at a temperature more than 120° C. were pressed at 270 kPa so as to be bonded together.

Thus, as described above with reference to FIGS. 3A and 3B, the sealing agent 5A was heat-cured into the second sealing part 5. As a result, the first substrate 1 and the second substrate 2 were bonded together. In addition, the first sealing part 3 was compressed such that its top surface was in contact with the first substrate 1.

After that, the electrolytic solution was injected into the spaces between the bonded substrates 1 and 2. In this Example, holes were formed in advance with a diamond drill in the second substrate 2 having the counter electrodes 8 thereon; and the electrolytic solution was injected through these holes. The electrolytic solution was prepared as a solution containing 0.01 mol/L TEMPO in ethylmethylimidazolium bis(trifluoromethanesulfonyl)imide. Thus, the photoelectric conversion module in Example 1 was obtained.

This photoelectric conversion module was found to have an open circuit voltage of 3.4 V. This result indicates that liquid junction between cells does not occur and the five cells are connected in series.

The photoelectric conversion module in Example 1 was found to have an aperture ratio (light-receiving area/whole module area) of 90%, which is a high aperture ratio. This aperture ratio was calculated from the “whole module area”, which denotes the area of the surface of the first substrate 1, and the “light-receiving area”, which denotes the total area of cells viewed in the direction normal to the first substrate 1 (the total area of portions surrounded by the first sealing part 3 and the second sealing part 5).

The sealing material of the first sealing part 3 was found to have a Young's modulus of 12 MPa or less. The Young's modulus (apparent compressive elastic modulus) of the sealing material forming the first sealing part can be determined in the following manner. The first sealing part is formed so as to have a predetermined pattern between a pair of substrates in the same manner as in the actual element production. A compressive stress is applied to these substrates and an area variation in the sealing part (a variation in the area of the sealing part viewed in the direction normal to the substrates) is determined. On the basis of the stress and the area variation, the Young's modulus (apparent compressive elastic modulus) of the sealing material can be calculated.

### Comparative Example 1

A photoelectric conversion module was produced as in Example 1 except that the silicone resin serving as the sealing material of the first sealing part 3 in Example 1 was replaced by a thermosetting epoxy resin (TB2023B manufactured by Three Bond).

The photoelectric conversion module obtained in Comparative example 1 was found to have an aperture ratio of 90%, which is a high aperture ratio. However, the photoelectric conversion module in Comparative example 1 was found to have an open circuit voltage of 0.7 V, which indicates occurrence of liquid junction between cells. The sealing material of the first sealing part 3 was found to have a Young's modulus of 2000 MPa or more.

### Example 2

A photoelectric conversion module was produced as in Example 1 except that the silicone resin serving as the sealing material of the first sealing part 3 in Example 1 was replaced by an acrylate resin (TB3018 manufactured by ThreeBond).

The photoelectric conversion module in Example 2 was found to have an open circuit voltage of 3.6 V. This result indicates that liquid junction between cells does not occur and the five cells are connected in series. The photoelectric conversion module obtained in Example 2 was found to have an aperture ratio of 90%, which is a high aperture ratio. The sealing material of the first sealing part 3 was found to have a Young's modulus of 80 MPa or less.

The above-described results indicate that the embodiments can achieve a high aperture ratio and enhancement of the capability of confining the electrolytic solution.

The sealing materials of the first and second sealing parts 3 and 5 according to the embodiments are not limited to those used in Examples. Similar advantages are also provided in cases of using, as the sealing material of the first sealing part 3, another material having an appropriate elasticity, that is, a Young's modulus of a predetermined value or less. The sealing material of the second sealing part 5 is also not limited to the above-described thermosetting resin and various materials that exhibit adhesion to substrates can be used.

A photoelectric conversion element according to an embodiment of the present disclosure can be used as, for example, a dye-sensitized power generation element that can generate power even in environments having a relatively low illuminance, such as indoors. In particular, the photoelectric conversion element can be used as a small-sized photoelectric conversion module.

What is claimed is:

1. A photoelectric conversion element comprising:
a first substrate;
a second substrate facing the first substrate;
cells located between the first substrate and the second substrate and arranged in an aggregate in a direction parallel to a surface of the first substrate, each of the cells including: a photoanode including a conductive layer located on the first substrate, a semiconductor layer located on the conductive layer, and a photosensitizer located on the semiconductor layer; a counter electrode located on the second substrate and facing the photoanode; and an electrolytic solution located between the photoanode and the counter electrode;
a first sealing part located between two of the cells that adjoin each other, the first sealing part comprising a first sealing material and suppressing contact between the electrolytic solutions included in the two of the cells; and
a second sealing part located on a periphery of the aggregate of the cells and comprising a second sealing material that has a higher Young's modulus than a Young's modulus of the first sealing material.

2. The photoelectric conversion element according to claim 1, wherein a Young's modulus of the first sealing material is 1 MPa or more and 500 MPa or less.

3. The photoelectric conversion element according to claim 2, wherein the Young's modulus of the first sealing material is 20 MPa or less.

4. The photoelectric conversion element according to claim 1, wherein the first sealing material is a silicone rubber.

5. The photoelectric conversion element according to claim 1, wherein the first sealing material is an acrylate resin.

6. The photoelectric conversion element according to claim 1, wherein, when viewed from a normal direction of the surface of the first substrate, a thickness of the first sealing part is smaller than a thickness of the second sealing part.

7. The photoelectric conversion element according to claim 1, wherein, when viewed from a normal direction of the surface of the first substrate, the thickness of the first sealing part is 1 mm or less.

8. The photoelectric conversion element according to claim 1, wherein the first sealing part is compressed between the first substrate and the second substrate.
